(19) United States
(12) Patent Application Publication
(10) Pub. No.: US 2026/0307619 A1
(43) Pub. Date: Oct. 8, 2026

(54) REMOTE VEHICLE DISABLING SYSTEM FOR LAW ENFORCEMENT

(71) Applicants: Kenneth Burrell, Houston, TX (US); Justin Burrell, Houston, TX (US)

(72) Inventors: Kenneth Burrell, Houston, TX (US); Justin Burrell, Houston, TX (US)

(21) Appl. No.: 19/169,116

(22) Filed: Apr. 3, 2025

(51) Int. Cl. B60R 25/045; B60K 35/10

(52) U.S. Cl. CPC B60R 25/045; B60K 35/10; B60K 2360/1438; B60R 2325/101; B60R 2325/103

(57) ABSTRACT

A remote vehicle disabling system for law enforcement includes a control device and a security device. The control device is designed to be installed in a law enforcement vehicle. The control device includes a microprocessor, an interface, and a control transceiver. The interface is designed for input of a vehicle identification to disable a vehicle in a pursuit scenario. The security device is designed to be installed in the vehicle. The security device includes an engine control unit, a microchip, and a security transceiver. The microchip is connected to the engine control unit to control operation of the engine control unit in response to the disable command. The microchip is designed to store the vehicle identification. The security transceiver is connected to the microchip to wirelessly receive and transmit the disable command from the control device to disable the vehicle in a pursuit scenario.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to vehicle disabling devices for law enforcement and more particularly pertains to a new remote vehicle disabling system for law enforcement. Police often have to pursue a fleeing suspect in a vehicle, which can be dangerous to the police, the suspect, and any bystanders. Spike strips and similar devices are used to physically disable a vehicle, but these can also be dangerous and ineffective if used improperly. The new remote vehicle disabling system allows law enforcement to remotely disable a fleeing vehicle by wirelessly transmitting a disable command to a control in the vehicle, which in turn safely shuts down the battery or engine.

### (2) Description of Related Art Including Information Disclosed Under 37 CFR 1.97 and 1.98

The prior art relates to vehicle disabling devices for law enforcement. The prior art, as best understood, does not disclose a remote vehicle disabling system for law enforcement that includes a control device installed in a law enforcement vehicle and a security device installed in a vehicle. The control device is designed for input of a vehicle identification to disable a vehicle in a pursuit scenario by wirelessly transmitting a disable command to the vehicle having the vehicle identification.

### (h) BRIEF SUMMARY OF THE INVENTION

An embodiment of the disclosure meets the needs presented above in a remote vehicle disabling system generally comprising a control device and a security device. The control device is designed to be installed in a law enforcement vehicle. The control device includes a microprocessor, an interface, and a control transceiver. The interface is connected to the control microprocessor. The interface is designed for input of a vehicle identification to disable a vehicle in a pursuit scenario. The control transceiver is connected to the microprocessor to receive and wirelessly transmit a disable command from the interface. The security device is designed to be installed in the vehicle. The security device includes an engine control unit, a microchip, and a security transceiver. The engine control unit is designed to be connected to a battery or engine of the vehicle. The microchip is connected to the engine control unit to control operation of the engine control unit in response to the disable command. The microchip is designed to store the vehicle identification. The security transceiver is connected to the microchip to wirelessly receive and transmit the disable command from the control device to disable the vehicle in a pursuit scenario.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a remote vehicle disabling system according to an embodiment of the disclosure.

FIG. 2 is a close-up view of a component of an embodiment of the disclosure.

FIG. 3 is a side view of an embodiment of the disclosure in use.

FIG. 4 is a block diagram view of an embodiment of the disclosure.

### (j) DETAILED DESCRIPTION OF THE INVENTION

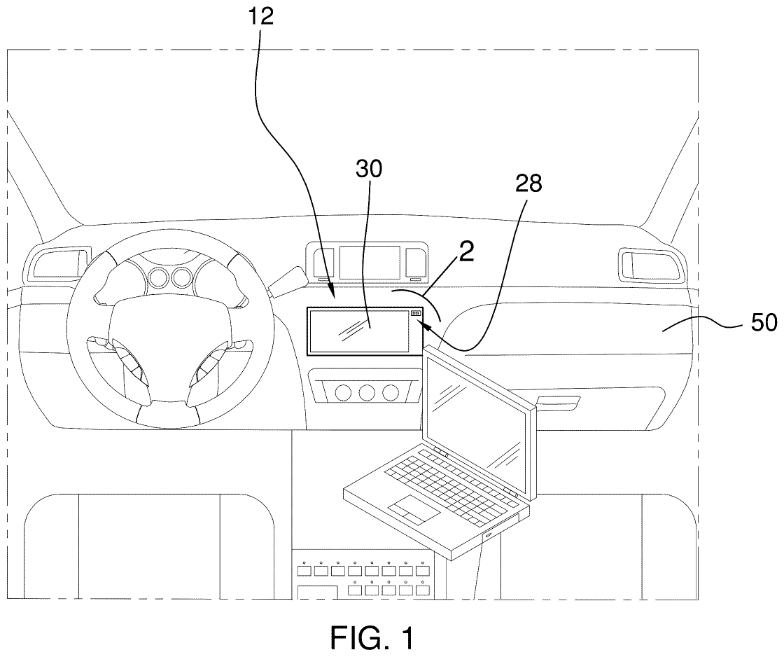

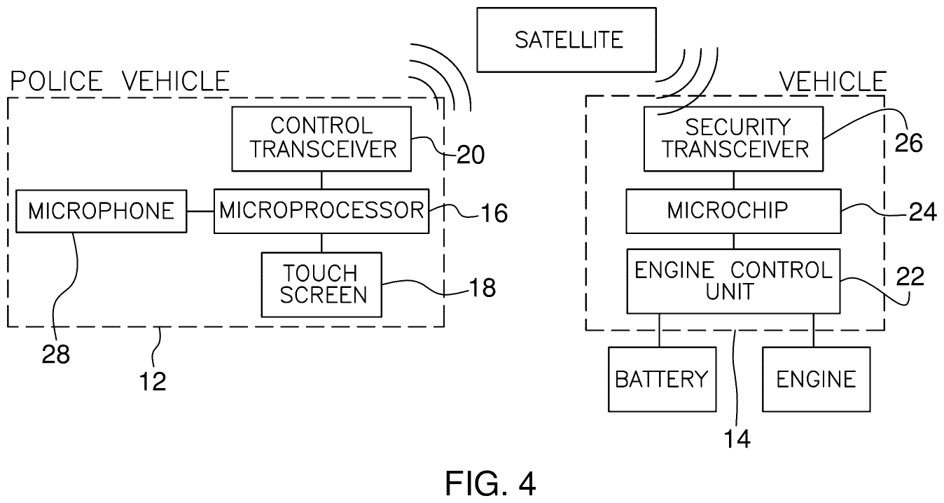

With reference now to the drawings, and in particular to FIGS. 1 through 4 thereof, a new remote vehicle disabling system embodying the principles and concepts of an embodiment of the disclosure and generally designated by the reference numeral 10 will be described.

As best illustrated in FIGS. 1 through 4, the remote vehicle disabling system 10 generally comprises a control device 12 and a security device 14. The control device 12 is designed to be installed in a law enforcement vehicle 50. The control device 12 includes a microprocessor 16, an interface 18, and a control transceiver 20. The interface 18 is connected to the microprocessor 16. The interface 18 is designed for input of a vehicle identification to disable a vehicle 60 in a pursuit scenario. The control transceiver 20 is connected to the microprocessor 16 to receive and wirelessly transmit a disable command from the interface 18. The security device 14 is designed to be installed in the vehicle 60. The security device 14 includes an engine control unit 22, a microchip 24, and a security transceiver 26. The engine control unit 22 is designed to be connected to a battery or engine of the vehicle 60. The microchip 24 is connected to the engine control unit 22 to control operation of the engine control unit 22 in response to the disable command. The microchip 24 is designed to store the vehicle identification. The security transceiver 26 is connected to the microchip 24 to wirelessly receive and transmit the disable command from the control device 12 to disable the vehicle 60 in a pursuit scenario.

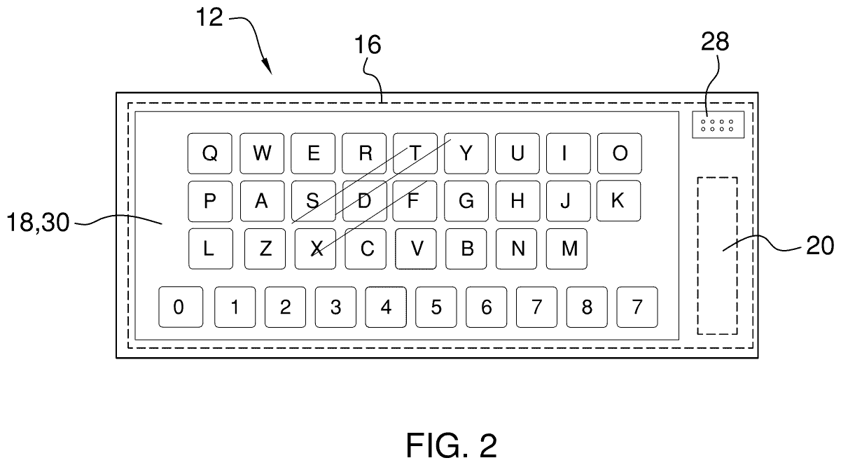

In the exemplary embodiment in FIG. 2, the interface 18 includes a microphone 28 to input the vehicle identification by voice. However, in another possible embodiment, the microphone 28 could be omitted.

In the exemplary embodiment in FIG. 2, the interface 18 includes a touchscreen 30 having alphanumeric characters to input the vehicle identification. In another possible embodiment, the touchscreen 30 could have other symbols and images. The touchscreen 30 is designed to be mounted in a dashboard of the law enforcement vehicle 50, as shown in FIG. 1.

The vehicle identification is an alphanumeric code stored on the microchip 24. In another possible embodiment, the vehicle identification could be a QR code or other type of unique identifier. In another possible embodiment, the alphanumeric code could be linked to other information, such as license plate, which could be entered into the remote vehicle disabling system 10.

In another possible embodiment, the remote vehicle disabling system 10 can include GPS technology to determine the relative position of the law enforcement vehicle 50 to the vehicle 60 being pursued. For example, if the law enforcement vehicle 50 is not within a certain distance from the vehicle 60, then the remote vehicle disabling system 10 will not function so as to prevent accidental disabling of an incorrect vehicle by inaccurate entry of the vehicle identification.

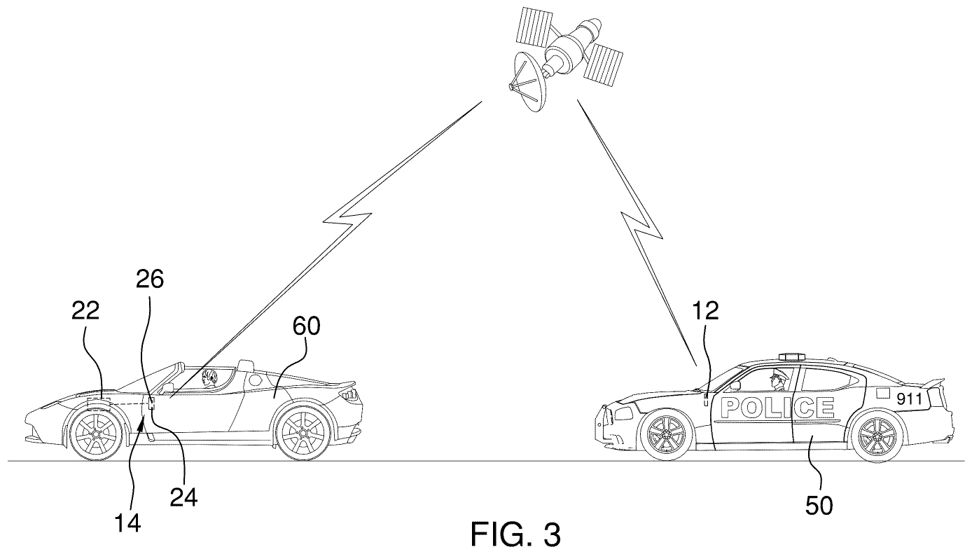

The control transceiver 20 and the security transceiver 26 are designed to communicate wirelessly in any suitable manner, such as via a satellite network, as shown in FIG. 3, or via Bluetooth connection or near field communication.

The remote vehicle disabling system 10 is used to disable the vehicle 60 in a pursuit scenario. When a police office is in pursuit of the vehicle 60 of a suspect, the police officer can enter the vehicle identification of the vehicle 60 into the interface 18, such as via the touchscreen 30 by typing in the alphanumeric code or by speaking the code into the microphone 28. The disable command is then wirelessly transmitted from the control transceiver 20 of the control device 12 to the security transceiver 26 of the security device 14. The engine control unit 22 is in turn activated by the microchip 24, which results in the disabling of a battery or an engine of the vehicle 60. In this manner, the vehicle 60 is brought to a stop so the police officer can arrest the driver of the vehicle 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A remote vehicle disabling system for law enforcement comprising:
a control device, said control device being configured to be installed in a law enforcement vehicle, said control device including:
a microprocessor;
an interface, said interface being connected to said microprocessor, said interface being configured for input of a vehicle identification to disable a vehicle in a pursuit scenario;
a control transceiver, said control transceiver being connected to said microprocessor to receive and wirelessly transmit a disable command from said interface; and
a security device, said security device being configured to be installed in the vehicle, said security device including:
an engine control unit, said engine control unit being configured to be connected to a battery or engine of the vehicle;
a microchip, said microchip being connected to said engine control unit to control operation of said engine control unit in response to the disable command, said microchip being configured to store the vehicle identification; and
a security transceiver, said security transceiver being connected to said microchip to wirelessly receive and transmit the disable command from said control device to disable the vehicle in a pursuit scenario.

2. The remote vehicle disabling system of claim 1, wherein said interface includes a microphone to input the vehicle information by voice.

3. The remote vehicle disabling system of claim 1, wherein said interface includes a touchscreen having alphanumeric characters to input the vehicle information.

4. The remote vehicle disabling system of claim 1, wherein said touchscreen is configured to be mounted in a dashboard of the law enforcement vehicle.

5. The remote vehicle disabling system of claim 1, wherein said vehicle identification is an alphanumeric code stored on said microchip.

6. The remote vehicle disabling system of claim 1, wherein said control transceiver and said security transceiver are configured to communicate wirelessly via a satellite network.

7. The remote vehicle disabling system of claim 1, wherein said control transceiver and said security transceiver are configured to communicate wirelessly via Bluetooth connection.

8. The remote vehicle disabling system of claim 1, wherein said control transceiver and said security transceiver are configured to communicate wirelessly via near field communication.

9. The remote vehicle disabling system of claim 2, wherein said interface includes a touchscreen having alphanumeric characters to input the vehicle information.

10. The remote vehicle disabling system of claim 9, wherein said touchscreen is configured to be mounted in a dashboard of the law enforcement vehicle.

11. The remote vehicle disabling system of claim 10, wherein said vehicle identification is an alphanumeric code stored on said microchip.

12. The remote vehicle disabling system of claim 11, wherein said control transceiver and said security transceiver are configured to communicate wirelessly via a satellite network.

13. The remote vehicle disabling system of claim 11, wherein said control transceiver and said security transceiver are configured to communicate wirelessly via Bluetooth connection.

14. The remote vehicle disabling system of claim 11, wherein said control transceiver and said security transceiver are configured to communicate wirelessly via near field communication.

15. A method of disabling a vehicle in a pursuit scenario, said method comprising the steps of:
providing a remote vehicle disabling system for law enforcement comprising:
a control device, said control device being configured to be installed in a law enforcement vehicle, said control device including:
a microprocessor;
an interface, said interface being connected to said microprocessor, said interface being configured for input of a vehicle identification to disable a vehicle in a pursuit scenario;
a control transceiver, said control transceiver being connected to said microprocessor to receive and wirelessly transmit a disable command from said interface; and
a security device, said security device being configured to be installed in the vehicle, said security device including:
an engine control unit, said engine control unit being configured to be connected to a battery or engine of the vehicle;
a microchip, said microchip being connected to said engine control unit to control operation of said engine control unit in response to the disable command, said microchip being configured to store the vehicle identification; and
a security transceiver, said security transceiver being connected to said microchip to wirelessly receive and transmit the disable command from said control device to disable the vehicle in a pursuit scenario;
pursuing a vehicle of a suspect in a law enforcement vehicle;
entering vehicle information of the vehicle into the interface;
wirelessly transmitting a disable command from said control transceiver to said security transceiver; and
activating said engine control unit and disabling a battery or engine of the vehicle.
